(19) United States
(12) Patent Application Publication
(10) Pub. No.: US 2024/0410742 A1
(43) Pub. Date: Dec. 12, 2024

(54) MIRROR-ASSISTED THREE-DIMENSIONAL (3D) CONTINUOUSLY SCANNING LASER VIBROMETER SYSTEMS AND METHODS FOR DETERMINING PANORAMIC OPERATING DEFLECTION SHAPES OF A STRUCTURE WITH MULTIPLE SIDES

(71) Applicant: UNIVERSITY OF MARYLAND, BALTIMORE COUNTY, Baltimore, MD (US)

(72) Inventors: Weidong Zhu, Halethorpe, MD (US); Ke Yuan, Halethorpe, MD (US)

(21) Appl. No.: 18/734,754

(22) Filed: Jun. 5, 2024

Related U.S. Application Data
(60) Provisional application No. 63/506,874, filed on Jun. 8, 2023.
(60) Provisional application No. 63/506,876, filed on Jun. 8, 2023.

(51) Int. Cl. G01H 9/00; G01N 29/24; G01N 29/265

(52) U.S. Cl. CPC G01H 9/00; G01N 29/2418; G01N 29/265

(57) ABSTRACT

3D continuously scanning laser vibrometer (CSLV) systems and methods for determining operating deflection shapes (ODSs) of a structure with multiple sides are disclosed. A system includes laser heads configured to be positioned for scanning one or more first sides of a structure within a field-of-view (FOV) of the laser heads. The system also includes a mirror positioned for reflection for enabling the laser heads to scan one or more second sides of the structure beyond the FOVs of the laser heads. The computing device controls the laser heads to scan the first side(s) of the structure. The computing device controls the laser heads to point towards the mirror for scanning the at second side(s) of the structure. The computing device is also configured to determine ODSs of the structure based on measured 3D vibrations of the first side(s) of the structure and the second side(s) of the structure.

### CROSS REFERENCE TO RELATED APPLICATIONS

This application claims priority to U.S. Provisional Patent Application No. 63/506,874, filed Jun. 8, 2023, and titled MIRROR-ASSISTED 3D CONTINUOUSLY SCANNING LASER DOPPLER I VIBROMETRY FOR MEASURING PANORAMIC 3D OPERATING DEFLECTION SHAPES OF A STRUCTURE, and to U.S. Provisional Patent Application No. 63/506,876, filed Jun. 8, 2023, and titled GENERAL-PURPOSE 3D CONTINUOUS SCANNING LASER VIBROMETRY FOR 3D VIBRATION MEASUREMENTS AND MODAL PARAMETER IDENTIFICATION FOR STRUCTURES WITH ARBITRARILY CURVED SURFACES; the contents of which are incorporated herein by reference in their entireties.

### FEDERALLY SPONSORED RESEARCH OR DEVELOPMENT

This invention was made with government support under Federal Grant No. CMMI-1763024, awarded by the National Science Foundation. The government has certain rights to this invention.

### TECHNICAL FIELD

The presently disclosed subject matter relates generally to three-dimensional (3D) continuous scanning laser vibrometry. Particularly, the presently disclosed subject matter relates to 3D continuously scanning laser vibrometer (CSLV) systems and methods for determining operating deflection shapes (ODSs) of a structure with multiple sides.

### BACKGROUND

Continuously scanning laser Doppler vibrometers (CSLDVs) have been developed to significantly improve efficiency and spatial resolution of vibration measurement of structures. CSLDVs have been possibly made by adding two orthogonal scan mirrors in front of a single-point laser Doppler vibrometer. Two scan mirrors can be referred to as X and Y mirrors based on their rotation axes, respectively. During CSLDV measurement, two scan mirrors can be controlled to continuously rotate about their rotation axes, and the laser spot of the CSLDV can continuously move along a pre-designed scan trajectory on the structure, which is a major difference compared to a conventional scanning laser Doppler vibrometer (SLDV) system that has a point-by-point scanning capability. Researchers who focused on this area developed various methods for processing response of a structure from CSLDV measurement and identifying its operating deflection shapes (ODSs) and modal parameters, such as the polynomial method and demodulation for ODS identification of the structure under sinusoidal excitation, the lifting method for modal parameter identification of the structure under impact excitation, the improved lifting method and improved demodulation method for modal parameter identification of a rotating structure under random excitation, and the extended demodulation method for 3D modal parameter identification of a beam under random excitation. Dense vibration of a structure from CSLDV measurement can be used to identify its damages via curvatures of its ODSs or mode shapes.

These studies mainly focused on using a CSLDV with one laser head, which can be referred to as a 1D CSLDV, to measure transverse vibration of a structure. One approach to measure 3D vibration of the structure is to place the laser head of the CSLDV at three independent positions and transform measured velocity response to three components along three orthogonal directions of a coordinate system. One study measured 3D vibration of a turbine blade under multi-sine excitation using the CSLDV with the assistance of a Microsoft Kinect. Another study proposed a calibration method and a velocity transformation method to measure 3D vibration of a beam, and reported good agreement between 3D vibration components from CSLDV measurement and those from a commercial Polytec 3D SLDV PSV-500-3D. Recently, a novel 3D CSLDV system with three laser heads was developed by the authors' group to measure 3D vibration of a structure. Experimental investigations were conducted on beams and plates by using the 3D CSLDV system to identify their ODSs and modal parameters such as natural frequencies and mode shapes. Experimental results showed that the 3D CSLDV system had the same level of accuracy as that of a commercial Polytec 3D SLDV PSV-500-3D system, but had much higher measurement efficiency than the latter. The 3D CSLDV system was subsequently improved to measure 3D ODSs and mode shapes of a turbine blade with a curved surface. A novel scan trajectory design method based on the 3D profile of the structure and calibration results of the 3D CSLDV system was developed in these studies, and 3D CSLDV measurements were conducted on the turbine blade to identify its ODSs under sinusoidal excitation and its mode shapes under random excitation. However, the 3D CSLDV system can be limited by its field of view (FOV), which is a common problem for optical-based measurement devices, and cannot obtain full-field vibration of a structure with difficult-to-access areas, such as side and back surfaces of a cylindrical structure. Moving the 3D CSLDV system to different positions to measure different parts of the structure is not practical during 3D CSLDV measurement, since the system needs be re-calibrated once it is moved, which is time-consuming and can introduce measurement errors.

One study developed an experimental modal testing approach to obtain and stitch mode shapes of both surfaces of a turbine blade using a SLDV system with the assistance of four alignment objects. The SLDV system was moved once in the experiment to measure vibration of the back side of the turbine blade. However, the proposed method is a two-surface measurement technique and can be only applied to a structure with two parallel surfaces. Another approach to extend the FOV of an optical-based measurement device, such as a digital image correlation (DIC) system and a laser Doppler vibrometer, is using a mirror or multiple mirrors. The major advantage of a mirror-assisted method is that it can be used to measure deformation or vibration of multiple surfaces of a structure and obtain its panoramic deformation or vibration shapes without moving the measurement system. During DIC measurement, deformation of a difficult-to-access area of the structure can be captured via its virtual image behind the mirror. Pan and Chen [16,17] developed a multi-view DIC method with the assistance of two orthogonal planar mirrors. Methods for transformation and reconstruction of virtual surfaces of the structure to and at their real positions, respectively, were proposed in their studies. The methodology was used in material tests of a planar and a cylindrical specimen, respectively, to provide their panoramic shapes and deformations. However, the above studies on DIC measurement focused on static tests of structures.

To measure vibration of a structure with difficult-to-access areas, a SLDV system can be used with the assistance of a mirror or multiple mirrors. One study conducted full-field strain measurement of a joined aluminum assembly that contained two C-channel legs and a flat top member using a 3D SLDV system and two mirrors, where two measured surfaces were orthogonal to each other. Another study measured dual-surface vibration of a pyramidal truss sandwich panel using a 3D SLDV system and a mirror to identify its mode shapes and validate its finite element (FE) model. However, both structures in the above studies had flat surfaces and the SLDV system had a point-by-point scanning mode. It is challenging to conduct 3D vibration measurement of a structure with curved and difficult-to-access areas, such as a cylindrical structure, using the 3D CSLDV system. Using an 360°-oscillating stand to support the cylindrical structure and placing a continuously-rotating 45° mirror inside the cylindrical structure are two methodologies developed to measure full-field vibration of the structure using the 1D CSLDV. However, the former is not practical for a large and heavy-weight structure since it cannot be easily moved by the oscillating stand, and the limitation of the latter is that the cylindrical structure must be hollow and have a relatively large inner space for placing the rotating mirror inside it.

In view of the foregoing, there is a need for improved 3D laser vibrometer systems and techniques.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a schematic diagram of a 3D CSLDV system for determining ODSs of multiple structure sides in accordance with embodiments of the present disclosure;

FIG. 2 is a flow diagram of an example method for determining ODSs of multiple structure sides in accordance with embodiments of the present disclosure;

FIG. 3 is a diagram of a mirror-assisted 3D CSLDV system in accordance with embodiment of the present disclosure;

FIG. 4 is a diagram of system calibration based on the geometrical model of the scan mirror set and a reference object;

FIG. 5 is a schematic of vibration measurement of the area A1 of the test structure, which is in the FOV of the 3D CSLDV system;

FIG. 6 is a schematic of vibration measurement of the area A2 of the test structure, which is out of the FOV of the 3D CSLDV system;

FIG. 7 shows a schematic of velocity transformation for the area A2 of the test structure, which is out of the FOV of the 3D CSLDV system;

FIG. 8A depicts two strings used to hang the hollow cylinder specimen to simulate its free boundaries, and a speaker was used to excite the specimen using sinusoidal excitation with frequencies that are close to its natural frequencies;

FIG. 8B is a workflow diagram of 3D CSLDV measurement of the hollow cylinder specimen using the proposed mirror-assisted testing method

FIG. 9A is a diagram of profile scanning results of real areas of the hollow cylinder specimen and those of corresponding virtual areas behind the mirror;

FIG. 9B shows that scan trajectories for areas A2-A4 were converted to be along the same orientation as that for the area A1, which was in the FOV of the 3D CSLDV system;

FIG. 10 is a diagram of scan trajectories on real and virtual areas A2 and corresponding calculated incident scan trajectories on the mirror plane;

FIG. 11 shows velocity transformation from three laser heads to the global MCS for the area A2 of the hollow cylinder specimen under sinusoidal excitation with the frequency 1524 Hz;

FIG. 12 show components of 3D full-field ODSs of the hollow cylinder specimen under sinusoidal excitation with the frequency 1524 Hz along x, y, and z directions of the global MCS;

FIG. 13 shows components of 3D full-field ODSs of the hollow cylinder specimen under sinusoidal excitation with the frequency 1593 Hz along x, y, and z directions of the global MCS;

FIG. 14A shows 3D full-field ODS of the (2,0) mode of the hollow cylinder specimen from 3D CSLDV measurement;

FIG. 14B shows the corresponding mode shape from its FE model;

FIG. 15A shows 3D full-field ODS of the (2,1) mode of the hollow cylinder specimen from 3D CSLDV measurement; and

FIG. 15B shows the corresponding mode shape from its FE model.

### SUMMARY

The presently disclosed subject matter relates to 3D continuously scanning laser vibrometer (CSLV) systems and methods for determining operating deflection shapes (ODSs) of multiple structure sides. According to an aspect, a system includes first, second, and third laser heads configured to be positioned for scanning one or more first sides of a structure within a field-of-view (FOV) of the first, second, and third laser heads. The system also includes a mirror configured to be positioned for reflection for enabling the first, second, and third laser heads to scan one or more second sides of the structure beyond the FOVs of the first, second, and third laser heads. Further, the system includes a computing device operably connected to the first, second, and third laser heads. The computing device is configured to control the first, second, and third laser heads to scan the first side(s) of the structure. Further, the computing device is configured to measure the 3D vibrations of the first side(s) of the structure. The computing device is also configured to control the first, second, and third laser heads to point towards the mirror for scanning the at second side(s) of the structure. Further, the computing device is configured to measure the 3D vibrations of the second side(s) of the structure. The computing device is also configured to determine operating deflection shapes (ODSs) of the structure based on the measured 3D vibrations of the first side(s) of the structure and the second side(s) of the structure.

According to another aspect, a method includes positioning first, second, and third laser heads for scanning one or more first sides of a structure within field-of-views (FOVs) of the first, second, and third laser heads. The method also includes positioning a mirror for reflection for enabling the first, second, and third laser heads to scan the second side(s) of the structure beyond the FOVs of the first, second, and third laser heads. Further, the method includes controlling the first, second, and third laser heads to scan the first side(s) of the structure. The method also includes measuring the 3D vibrations of the first side(s) of the structure. Further, the method includes controlling the first, second, and third laser heads to point towards the mirror for scanning the second side(s) of the structure. The method also includes measuring 3D vibrations of the second side(s) of the structure. Further, the method includes determining operating deflection shapes (ODSs) of the structure based on the measured 3D vibrations of the first side(s) of the structure and the second side(s) of the structure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Unless otherwise defined, all technical and scientific terms used herein have the same meaning as commonly understood by one of skill in the art. In case of conflict, the present document, including definitions, will control. Various methods and materials are described herein, although methods and materials similar or equivalent to those described herein can be used in practice or testing of the present disclosure. All publications, patents, patent applications, and other references mentioned herein are incorporated by reference in their entirety. The materials, methods, and examples disclosed herein are illustrative only and not intended to be limiting.

Articles “a” and “an” are used herein to refer to one or to more than one (i.e. at least one) of the grammatical object of the article. By way of example, “an element” means at least one element and can include more than one element.

“About” and “approximately” are used to provide flexibility to a numerical range endpoint by providing that a given value may be “slightly above” or “slightly below” the endpoint without affecting the desired result, for example, +/−5%.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

The phrase “in one embodiment”, “in an embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the subject disclosure may be readily combined, without departing from the scope or spirit of the present disclosure.

As defined herein, “full-field” can be defined as vibrations of the whole surface of a structure or vibrations along the entire beam length of the structure.

As referred to herein, the term laser vibrometer system should be broadly construed. This system may include 3D continuously scanning laser Doppler vibrometer systems and 3D continuously scanning laser vibrometer systems. Such systems can measure the vibration in terms of velocity or displacement of a surface. It can do so by employing laser technology using or not using the Doppler shift principle to provide non-contact measurements.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. A user interface can include an input for allowing users to manipulate a computing device, and can include an output for allowing the computing device to present information and/or data, indicate the effects of the user's manipulation, etc.

In accordance with embodiments, a general-purpose 3D CSLDV system is disclosed and operable to measure 3D vibration of a structure with a curved surface. As a non-contact system, it can avoid the mass-loading problem in 3D vibration measurement using triaxial accelerometers. In previous studies, the 3D CSLDV system can measure 3D full-field vibration of a turbine blade with a curved surface and identify its operating deflection shapes (ODSs) and mode shapes. Systems and methods disclosed herein can use a mirror-assisted testing methodology for 3D CSLDV measurement that can measure vibration of difficult-to-access areas of a structure without moving the 3D CSLDV system during the test, and stitch ODSs of its different parts together to obtain its panoramic 3D ODSs. The present disclosure provides includes a scan trajectory design method that uses virtual areas of the structure behind the mirror to conduct continuous and synchronous scanning of three laser spots, and a velocity transformation method that uses virtual positions of three laser heads behind the mirror to stitch ODSs of different parts of the structure together. In experiments with the proposed methodology, 3D CSLDV measurement was conducted on an aluminum hollow cylinder specimen, which has difficult-to-access areas such as its side and back surfaces, with the assistance of the mirror to obtain its panoramic 3D ODSs corresponding to its first two modes. Comparison between identified ODSs of the hollow cylinder specimen from the experiment and mode shapes from its finite element model was made and modal assurance criterion values are larger than 0.98.

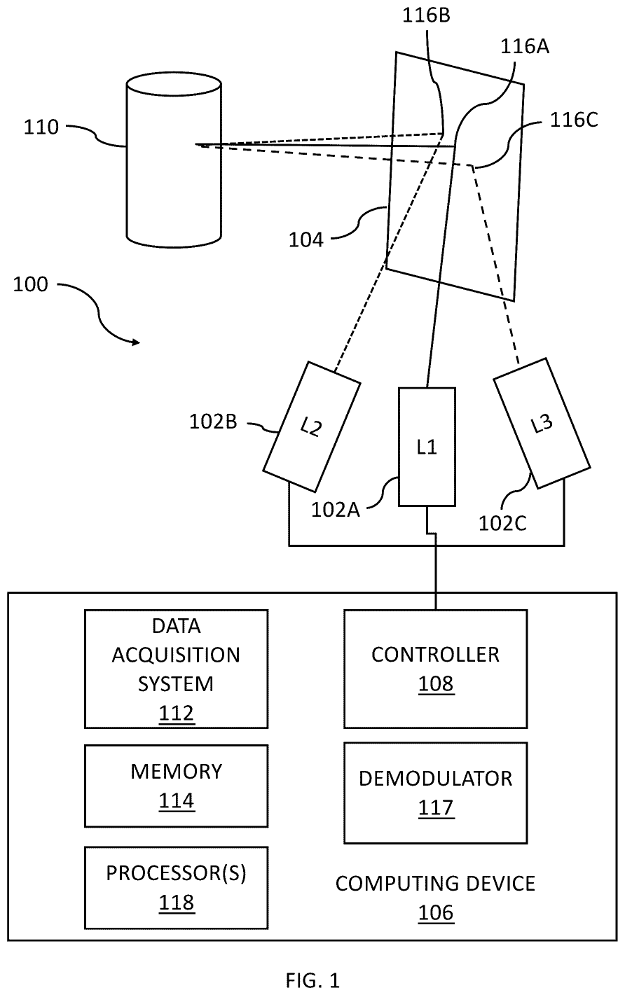

FIG. 1 illustrates a schematic diagram of a 3D CSLDV system 100 for determining ODSs of multiple structure sides in accordance with embodiments of the present disclosure. Referring to FIG. 1, the system 100 includes three laser heads 102A, 102B, and 102C (also labeled L1, L2, and L3, respectively), but it should be understood that the system 100 may alternatively include any suitable number of laser heads of suitable type. The system also includes a mirror 104 and a computing device 106. The computing device 106 includes a controller 108 operatively connected to laser heads 102A, 102B, and 102C for controlling the laser heads to scan sides of a structure 110. Further, the mirror 104 can be positioned for reflection for enabling laser heads 102A, 102B, and 102C to scan other sides of the structure 110 as described in more detail herein.

With continuing reference to FIG. 1, laser heads 102A, 102B, and 102C can be positioned for scanning one or more sides of the structure 110. Laser heads 102B and 102C can be positioned between about 30 degrees and 60 degrees relative to the laser head 102A. The structure 110 can have a curved outer surface within an FOV of laser heads 102A, 102B, and 102C. The controller 108 can control laser heads 102A, 102B, and 102C to scan the curved surface within the FOV for acquiring scan data of the surface. The acquired scan data can be suitably processed by a data acquisition system 112 of the controller 108, and stored in memory 114. In an example, the controller 108 can measure the 3D vibrations of the curved surface based on the acquired scan data.

In accordance with embodiments, the controller 108 can control laser heads 102A, 102B, and 102C to point towards the mirror 104 for scanning one or more other sides of the structure 110, which are different from and/or overlapping with the surface of the structure 110 within the FOV of laser heads 102A, 102B, and 102C. Therefore by use of the mirror 104 for reflection, laser heads 102A, 102B, and 102C can be controlled by the controller 108 to scan the surface(s) outside the FOV of laser heads 102A, 102B, and 102C. The acquired scan data can be suitably processed by the data acquisition system 112 of the controller 108, and stored in memory 114. The controller 108 can measure the 3D vibrations of the curved surface based on the acquired scan data.

The computing device 106 can determine ODSs of the structure 110 based on the measured 3D vibrations of the various sides of the structure 110. More particularly, the computing device 106 can determine ODSs based on the data acquired of the surface(s) of the structure 110 within the FOV of laser heads 102A, 102B, and 102C and also the data acquired of the surface(s) of the structure 110 outside of the FOV of laser heads 102A, 102B, and 102C due to use of the mirror 104. The computing device 106 can use this acquired data to measure deformation or vibration of multiple surfaces of the structure 110 and obtain its panoramic deformation or vibration shapes without moving the system 100. Further, during 3D CSLDV measurement, deformation of a difficult-to-access area or surfaces of the structure 110 can be captured via its virtual image behind the mirror 104. In embodiments, a demodulator 117 can implement a demodulation method for determining ODSs based on the acquired data.

It is noted that in this example only one mirror 104 is described as being used to scan surfaces of the structure 110 outside the FOV of laser heads 102A, 102B, and 102C. However, it should be understood that any suitable number of mirrors in any suitable configuration or position may be used to scan surfaces outside the FOV.

In embodiments, the controller 108 can virtual areas of the structure 110 behind the mirror 104 to conduct continuous and synchronous scanning of three laser spots 116A, 116B, and 116C, and to implement a velocity transformation method that uses virtual positions of laser heads 102A, 102B, and 102C to stitch ODSs of different parts of the structure 110 together.

The controller 108 may be implemented by any suitable hardware, software, and/or firmware. For example, the controller 108 may be implemented by memory 114 and one or more processors 118 of the computing device 106.

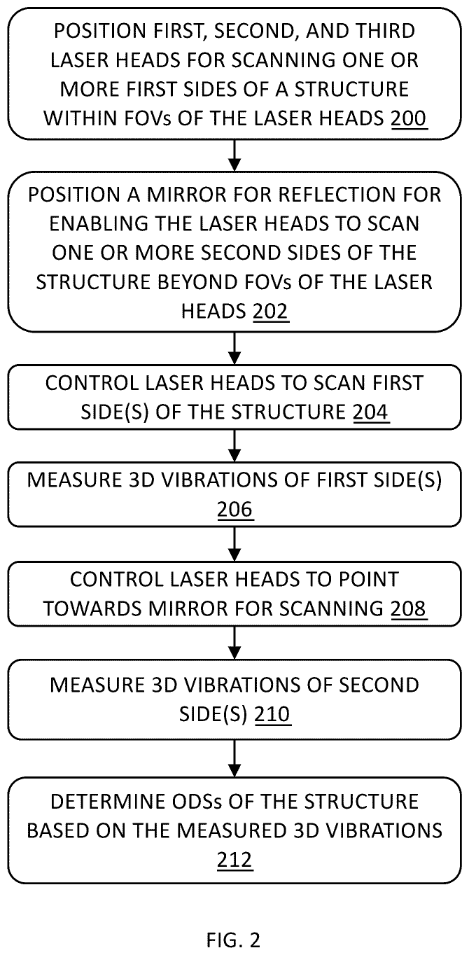

FIG. 2 illustrates a flow diagram of an example method for determining ODSs of multiple structure sides in accordance with embodiments of the present disclosure. The method of FIG. 2 is described by example as being implemented by the system 100 shown in FIG. 1, but it should be understood that the method may alternatively be implemented by any other suitable system.

Referring to FIG. 2, the method includes positioning 200 first, second, and third laser heads for scanning one or more first sides of a structure within field-of-views (FOVs) of the first, second, and third laser heads. For example, laser heads 102A, 102B, and 102C shown in FIG. 1 can be positioned for scanning a curved surface of the structure 110.

The method of FIG. 2 includes positioning 202 a mirror for reflection for enabling the first, second, and third laser heads to scan one or more second sides of the structure beyond the FOVs of the first, second, and third laser heads. Continuing the aforementioned example, the mirror 104 can be positioned such that laser heads 102A, 102B, and 102C can scan one or more other surfaces of the structure 110. These other surface(s) can be outside of the FOV of laser heads 102A, 102B, and 102C.

The method of FIG. 2 includes controlling 204 the first, second, and third laser heads to scan the first side(s) of the structure. Continuing the aforementioned example, the controller 108 can control laser heads 102A, 102B, and 102C to scan the surface(s) within the FOV of laser heads 102A, 102B, and 102C. Particularly, the controller 108 can control laser heads 102A, 102B, and 102C to continuously and synchronously move along the same scan trajectory on the FOV side of the structure. Laser heads 102A, 102B, and 102C can scan the structure under sinusoidal excitation.

The method of FIG. 2 includes measuring 206 the 3D vibrations of the first side(s) of the structure. Continuing the aforementioned example, the computing device 102 can use the acquired data of scanning the surface(s) within the FOV of laser heads 102A, 102B, and 102C for measuring 3D vibrations of those surface(s).

The method of FIG. 2 includes controlling 208 the first, second, and third laser heads to point towards the mirror for scanning the second side(s) of the structure. Continuing the aforementioned example, the controller 108 can control laser heads 102A, 102B, and 102C to scan the surface(s) outside of the FOV of laser heads 102A, 102B, and 102C. The controller 108 can control laser heads 102A, 102B, and 102C to use the mirror 104 for continuously and synchronously moving along the same scan trajectory on the other side of the structure. Laser heads 102A, 102B, and 102C can scan the structure under sinusoidal excitation.

The method of FIG. 2 includes measuring 210 the 3D vibrations of the second side(s) of the structure. Continuing the aforementioned example, the computing device 102 can use the acquired data of scanning the surface(s) within the FOV of laser heads 102A, 102B, and 102C for measuring 3D vibrations of those surface(s).

The method of FIG. 2 includes determining 212 ODSs of the structure based on the measured 3D vibrations of the first side(s) of the structure and the second side(s) of the structure. Continuing the aforementioned example, the demodulator 117 can determine ODSs of the structure based on the measured 3D vibrations of the first side(s) of the structure and the second side(s) of the structure. The computing device 106 can stitch together the ODSs for generating panoramic 3D operating shapes of the structure 110.

In accordance with embodiments, to measure vibration of a structure with difficult-to-access areas an SLDV system as disclosed herein can be used with the assistance of a mirror or multiple mirrors. It is challenging to conduct 3D vibration measurement of a structure with curved and difficult-to-access areas, such as a cylindrical structure, using the 3D CSLDV system. A novel mirror-assisted testing methodology for 3D CSLDV measurement is disclosed herein to measure vibration of difficult-to-access areas of a structure without moving the 3D CSLDV system during the test and stitch ODSs of its different parts together to obtain its panoramic 3D ODSs. The disclosed methodologies include a novel scan trajectory design method that uses virtual areas of the structure behind the mirror to conduct continuous and synchronous scanning of three laser spots, and a novel velocity transformation method that uses virtual positions of three laser heads behind the mirror to stitch ODSs of different parts of the structure together. In the experimental demonstration of the proposed methodology, an aluminum hollow cylinder specimen was used as the test structure, which has difficult-to-access areas such as its side and back surfaces. Sinusoidal excitation with frequencies close to natural frequencies of the hollow cylinder specimen were provided by a speaker to excite it; so identified ODSs were close to its mode shapes. The whole surface of the hollow cylinder specimen was segmented into four parts in the experiment. One of the four parts was in the FOV of the 3D CSLDV system and thus positioned to be directly scanned by it, while the other three parts were out of the FOV of the system and were scannable by placing the mirror at three different positions. A goal of the experiments was to recover vibration of virtual surfaces of the hollow cylinder specimen to a global coordinate system, which is significant for stitching ODSs of different parts of the specimen together and obtaining its panoramic 3D ODSs. Comparison between identified ODSs corresponding to the first two modes of the hollow cylinder specimen from the experiment and the corresponding mode shapes from its finite element model is made and modal assurance criterion (MAC) values are larger than 0.98. The major advancement of the disclosed method was avoiding moving both the test structure and 3D CSLDV system, which can introduce measurement errors. Moreover, a large inner space of the test structure is not required. The proposed method can therefore be used in more general scenarios in practice.

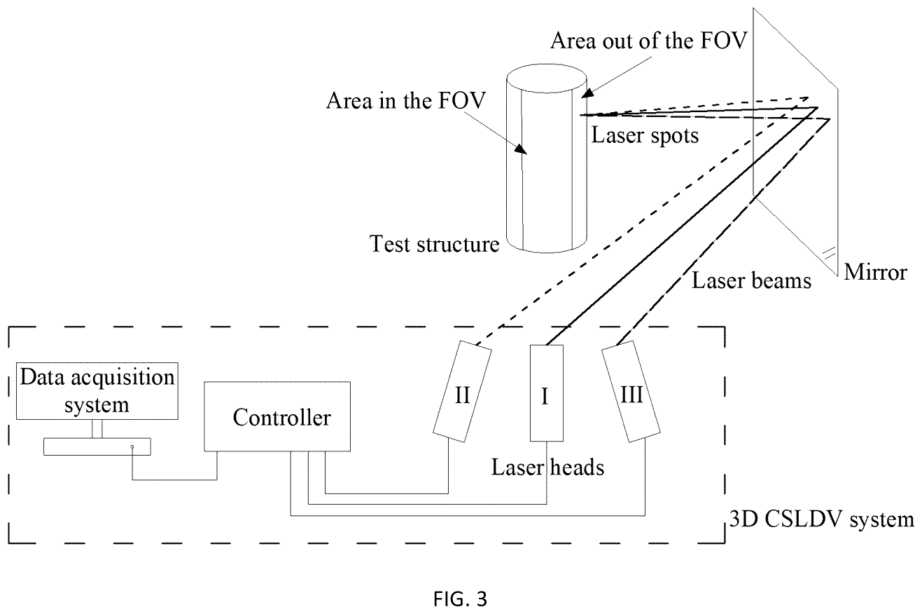

In accordance with embodiment, FIG. 3 illustrates a diagram of a mirror-assisted 3D CSLDV system in accordance with embodiment of the present disclosure. Referring to FIG. 3, laser head I has an internal geometry unit that can measure the 3D profile of the test structure with a curved surface. Scan mirror signals can be calculated using the spatial relation among three laser heads and the 3D profile of the structure, and inputted into the external controller to direct three laser spots to synchronously and continuously move along a desired scan trajectory on the surface of the structure. Velocities of a measurement point on the structure obtained by three laser heads can be transformed to a pre-defined global measurement coordinate system (MCS). Therefore, 3D vibration of the curved surface of the test structure that is in the FOV of the 3D CSLDV system, as shown in FIG. 3, can be directly measured. To direct laser spots of three laser heads to scan an area that is out of the FOV of the 3D CSLDV system, a mirror can be used to reflect their laser beams by adjusting its position and oblique angle, as shown in FIG. 3.

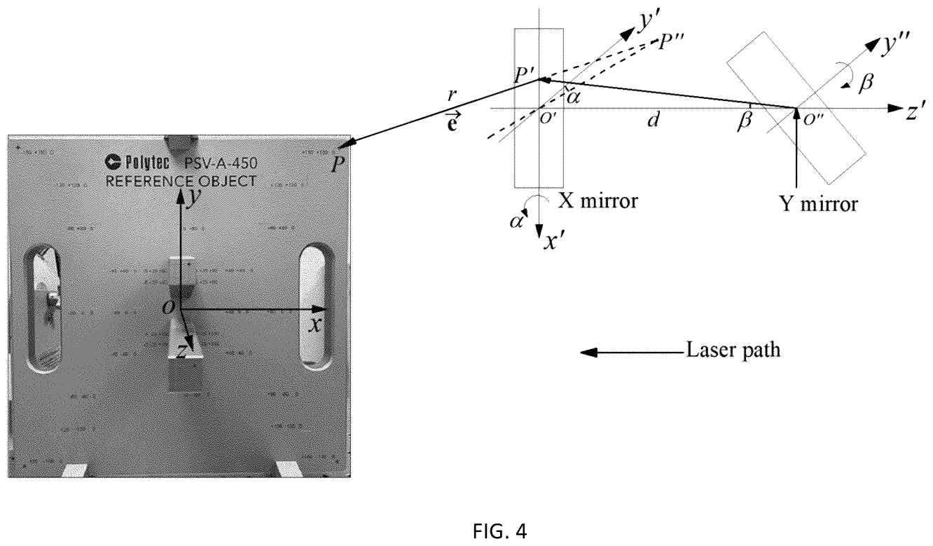

The methodology for calibrating the 3D CSLDV system, which is based on the geometrical model of the scan mirror set and a reference object Polytec PSV-A-450, is shown in FIG. 4, which illustrates a diagram of system calibration based on the geometrical model of the scan mirror set and a reference object. During system calibration, the reference object provides a MCS that is denoted as o-xyz, and the scan mirror set provides a vibrometer coordinate system (VCS) that is denoted as o′-x′y′z′. The system calibration aims to obtain relations between coordinates of a point in the MCS P_{MCS} and those in the VCS P_{VCS}, which can be written as

$${P}_{MCS} = R {P}_{VCS} + T , \qquad ( 1 )$$

where the vector T with a dimension of 3×1 denotes coordinates of the VCS origin o′ in the MCS, and the matrix R with a dimension of 3×3 is the direction cosine matrix from the MCS to the VCS.

Six points marked in the reference object are used as calibration points in this work. Their coordinates in the MCS are (−150,150,0), (150,150,0), (150,−150,0), (−150,−150,0), (−5,25,80), and (−5,−35,150). When a laser spot of a laser head is directed to one of calibration points P by inputting angles to scan mirrors, its coordinates in the MCS P_{MCS} can be directly obtained from the reference object, and its coordinates in the VCS P_{VCS} can be written as

$${P}_{VCS} = {[ - d tan β - r sin β , - r cos α cos β , - r sin α cos β ]}^{T} , \qquad ( 2 )$$

where the superscript T denotes transpose of a matrix, d is a known parameter for the laser head, α and β denote rotating angles of X and Y mirrors, respectively, and r is the measurable distance between the calibration point P and its corresponding incident point P′ on the X mirror. The unit directional vector of the laser path PP′ can be written as

$$e = {[ sin β , cos α cos β , sin α cos β ]}^{T} . \qquad ( 3 )$$

Following steps of the system calibration include solving an over-determined nonlinear problem

$$\vert {P}_{MCS}^{m} - {P}_{MCS}^{n} \vert = \vert {P}_{VCS}^{m} - {P}_{VCS}^{n} \vert \qquad ( 4 )$$

to obtain exact values of r for all six calibration points, where superscripts m and n are indices of calibration points, and solving an optimization problem

$$F ( T , R ) = δ = min {\sum }_{m = 1}^{6} \vert {P}_{MCS}^{m} - ( R {P}_{VCS}^{m} - T ) \vert . \qquad ( 5 )$$

Finally, the system calibration outputs three pairs of T and R matrices for three laser heads.

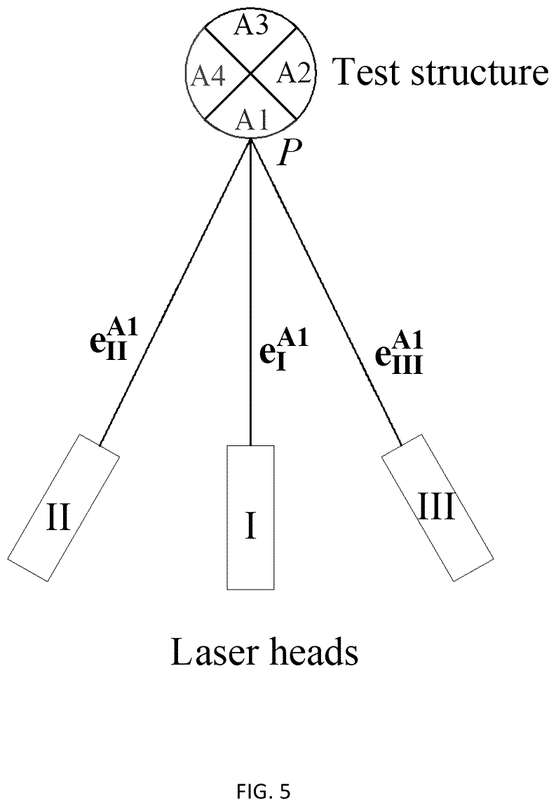

As shown in FIG. 5, the whole surface of the test structure, which is a hollow cylinder specimen in this work, can be segmented into four areas. FIG. 5 illustrates a schematic of vibration measurement of the area A1 of the test structure, which is in the FOV of the 3D CSLDV system. The area A1 is in the FOV of the 3D CSLDV system and areas A2-A4 are out of its FOV. This section shows the methodology for measuring vibration of the area A1 of the structure using the 3D CSLDV system. To conduct a synchronous scanning on the curved surface of the structure, coordinates of three laser spots of three laser heads are assumed to be the same in the MCS when they move along the scan trajectory. Therefore, Eq. (1) can be further written as

$${P}_{MCS} = {R}_{I} {P}_{VCS \_ I} + {T}_{I} = {R}_{II} {P}_{VCS \_ II} + {T}_{I I} = {R}_{III} {P}_{VCS \_ III} + {T}_{III} , \qquad ( 6 )$$

where subscripts I, II, and III are indices of three laser heads. To conduct a continuous scan along the scan trajectory, coordinates of measurement points in the MCS can be obtained by interpolating the 3D profile of the test structure. Coordinates of each measurement point in VCSs of three laser heads P_{VCS_I}, P_{VCS_II}, and P_{VCS_III} can be obtained by substituting their R and T matrices from the system calibration into Eq. (6). Rotating angles of scan mirrors in three laser heads can then be obtained by

$${a}_{I} = arctan ( {z}_{VCS \_ I} / {y}_{VCS \_ I} ) , {β}_{I} = arctan ( {x}_{VCS \_ I} / ( {y}_{VCS \_ I} / cos {a}_{I} - d ) ) , \qquad ( 7 a )$$

$${a}_{II} = arctan ( {z}_{VCS \_ II} / {y}_{VCS \_ II} ) , {β}_{II} = arctan ( {x}_{VCS \_ II} / ( {y}_{VCS \_ II} / cos {a}_{II} - d ) ) , \qquad ( 7 b )$$

$${a}_{III} = arctan ( {z}_{VCS \_ III} / {y}_{VCS \_ III} ) , {β}_{III} = arctan ( {x}_{VCS \_ III} / ( {y}_{VCS \_ III} / cos {a}_{III} - d ) ) . \qquad ( 7 c )$$

Finally, continuous and synchronous scanning can be conducted on the area A1 by feeding rotating angles back to three laser heads, and three time-velocity series V_{I}^{A1}, V_{II}^{A1}, and V_{III}^{A1}, where the superscript A1 denotes the corresponding area number, can be acquired by three laser heads, which completes vibration measurement on the area A1.

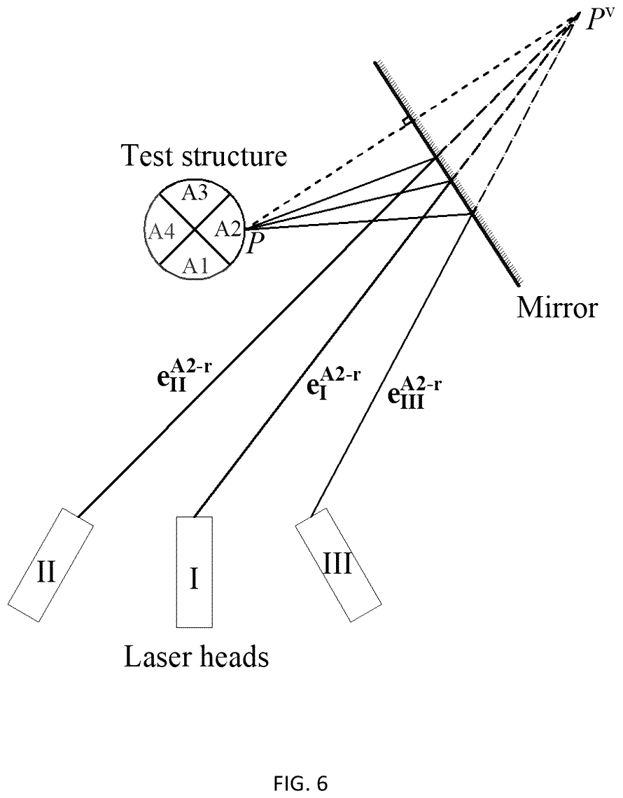

An example methodology for measuring vibration of areas A2-A4 of the test structure using the 3D CSLDV system is shown in FIG. 6, which illustrates a schematic of vibration measurement of the area A2 of the test structure, which is out of the FOV of the 3D CSLDV system. For each area, the mirror is placed at an appropriate position and its oblique angle is manually adjusted to ensure that all three laser spots can reach the whole area, and the mirror is fixed during measurement of the area. Coordinates of measurement points P and their virtual points P^{V} behind the mirror are both obtained in the MCS by the laser head I. Coordinates of real points P_{MCS} are used to reconstruct the panoramic surface of the test structure and recover vibration of virtual surfaces to the actual coordinate system. Based on the reflective configuration of the mirror, coordinates of virtual points P_{MCS}^{V} are used to replace their corresponding real points in Eq. (6) to conduct continuous and synchronous scanning on areas A2-A4, which yields

$${P}_{MCS}^{v} = {R}_{I} {P}_{VCS \_ I}^{v} + {T}_{I} = {R}_{II} {P}_{VCS \_ II}^{v} + {T}_{II} = {R}_{III} {P}_{VCS \_ III}^{v} + {T}_{III} . \qquad ( 8 )$$

Similarly, rotating angles of scan mirrors in laser heads can be determined using corresponding P_{VCS}^{v} and Eqs. 7(a)-7(c), and fed back to laser heads to conduct continuous and synchronous scanning on areas A2-A4. Time-velocity series acquired for areas A2-A4 can be denoted as V_{I}^{A2/A3/A4}, V_{II}^{A2/A3/A4}, and V_{III}^{A2/A3/A4}.

As shown in FIG. 5, directly acquired time-velocity series V_{I}^{A1}, V_{II}^{A1}, and V_{III}^{A1} of the area A1 can acquired along laser beams of three laser heads, respectively, whose unit directional vectors e_{I}^{A1}, e_{II}^{A1}, and e_{III}^{A1} can be determined by substituting corresponding rotating angles into Eq. (3). Time-velocity series V_{I}^{A1}, V_{II}^{A1}, and V_{III}^{A1} can then be transformed to velocity components along x, y, and z directions of the global MCS by

$${[ {V}_{x}^{A 1} , {V}_{y}^{A 1} , {V}_{z}^{A 1} ]}^{T} = {{[ {R}_{I} {e}_{I}^{A 1} , {R}_{II} {e}_{II}^{A 1} , {R}_{III} {e}_{III}^{A 1} ]}^{T} [ {V}_{I}^{A 1} , {V}_{II}^{A 1} , {V}_{III}^{A 1} ]}^{T} . \qquad ( 9 )$$

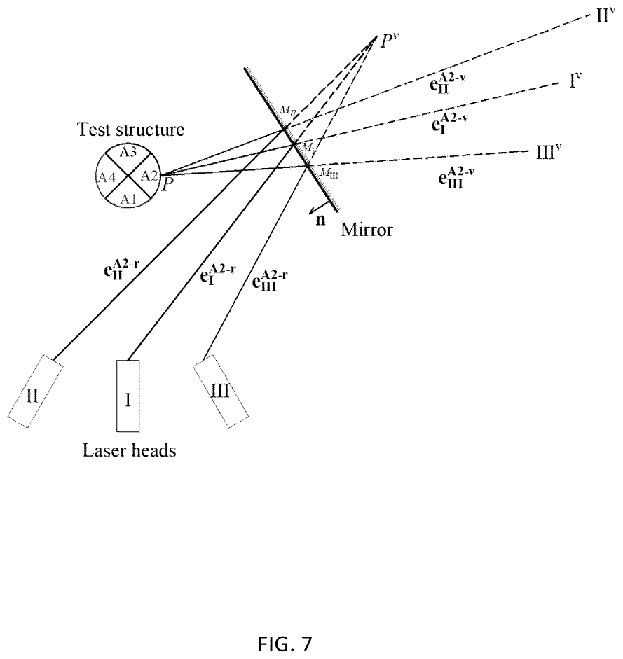

Acquired velocities of areas A2-A4 are along directions from measurement points P to virtual positions of laser heads behind the mirror. For instance, as shown in FIG. 7, time-velocity series V_{I}^{A2}, V_{II}^{A2}, and V_{III}^{A2} if of a point P on the area A2 are along virtual unit directional vectors e_{I}^{A2-v}, e_{II}^{A2-v}, and e_{III}^{A2-v}, respectively. FIG. 7 shows a schematic of velocity transformation for the area A2 of the test structure, which is out of the FOV of the 3D CSLDV system. Taking e_{I}^{A2-v} of the laser head I as an example, one has

$${e}_{I}^{A 2 - v} = \frac{{PM}_{I}^{A 2}}{\vert {PM}_{I}^{A 2} \vert} , \qquad ( 10 )$$

where M_{I}^{A2} denotes the incident point of the laser beam of the laser head I on the mirror for the area A2. It is actually the intersection point of the line that is from the laser head I to the virtual point P^{v} and the plane of the mirror. Therefore, its coordinates can be determined by using P^{v}, e_{I}^{A2-r}, and n, where e_{I}^{A2-r} can be determined by substituting corresponding rotating angles into Eq. (3), and n is the normal vector of the mirror plane that can be determined using any three points on the mirror. By obtaining e_{I}^{A2-v}, e_{II}^{A2-v}, and e_{III}^{A2-v}, time-velocity series V_{I}^{A2}, V_{II}^{A2}, and V_{III}^{V2} can be transformed to velocity components along x, y, and z directions of the global MCS by

$${[ {V}_{x}^{A 2} , {V}_{y}^{A 2} , {V}_{z}^{A 2} ]}^{T} = {{[ {e}_{I}^{A 2 - v} , {e}_{II}^{A 2 - v} , {e}_{III}^{A 2 - v} ]}^{T} [ {V}_{I}^{A 2} , {V}_{II}^{A 2} , {V}_{III}^{A 2} ]}^{T} . \qquad ( 11 )$$

By applying above methods based on virtual measurement points and virtual laser heads, measured vibration of areas A2-A4 can be recovered to the global MCS and reconstructed with their real coordinates.

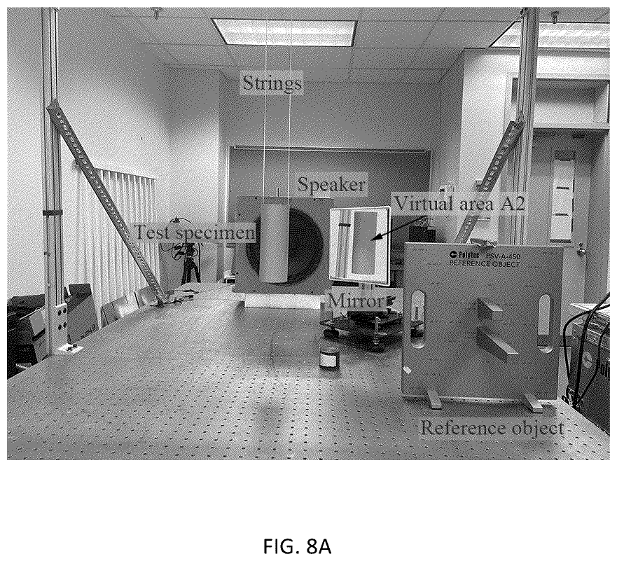

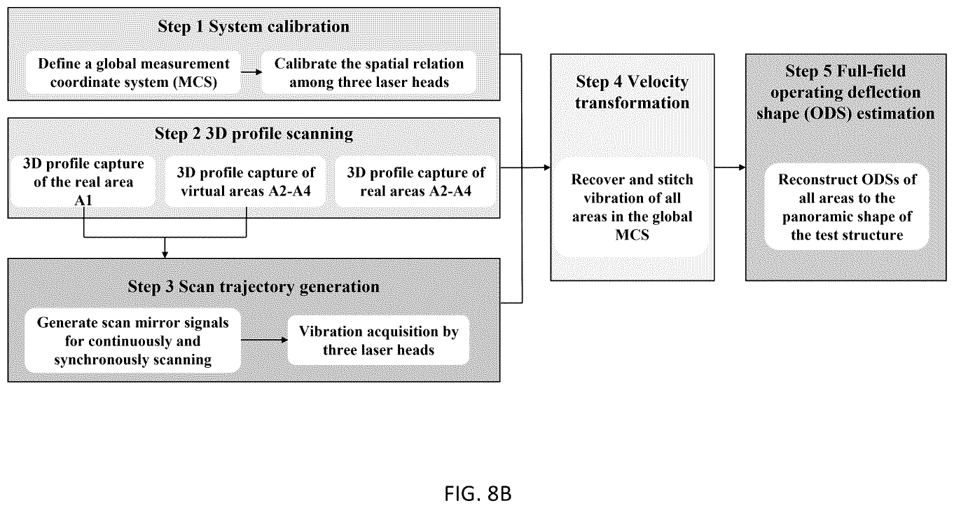

In experiments, an aluminum hollow cylinder specimen was used as the test structure in this work to validate the proposed mirror-assisted testing method using the 3D CSLDV system. It had a height of 205 mm, an inner diameter of 69.7 mm, and an outer diameter of 76 mm. As shown FIGS. 8A and 8B, two strings were used to hang the hollow cylinder specimen to simulate its free boundaries, and a speaker was used to excite the specimen using sinusoidal excitation with frequencies that are close to its natural frequencies. A grey reflective tape was attached on the outer surface of the hollow cylinder specimen to maximize back-scattering of laser light. A mirror was mounted to an adjustable frame and placed at a side of the hollow cylinder specimen. As discussed in Sec. 2, its oblique angle was manually adjusted to ensure that all three laser spots can reach to the whole desired area through its reflection. Note FIG. 8A shows the position and oblique angle of the mirror corresponding to measurement for the area A2, and the mirror was then moved to next positions corresponding areas A3 and A4, respectively, to complete full-field measurement.

The workflow of 3D CSLDV measurement of the hollow cylinder specimen using the proposed mirror-assisted testing method was shown FIG. 8B. In step 1, a global MCS was defined on the reference object shown FIG. 8A, which was fixed during the experiment. Based on the global MCS, three pairs of R and T matrices for three laser heads were outputted from the system calibration to indicate their spatial relation. Results of R and T matrices were shown in Table 1 and used to calculate the distance between each calibration point and its corresponding laser spot. A distance referred to as calibration error can be used to evaluate accuracy of the system calibration:

$${δ}^{m} = ‖ {P}_{{MCS}^{-}}^{m} ( T + {RP}_{VCS}^{m} ) ‖ , \qquad ( 12 )$$

where the superscript m has the same meaning as that in Eq. (4). Mean calibration errors from all six calibration points were 0.10 mm, 0.41 mm, and 0.10 mm for laser heads I, II, and III, respectively. Spot diameters of laser heads in this experiment were about 0.2 mm based on stand-off distances between front sides of laser heads and the reference object. One can see that mean calibration errors and laser spot diameters were of the same order.

TABLE 1
Results of R and T matrices from the system calibration

| Laser head | R | T |
|---|---|---|
| Laser head I | $[ \begin{matrix}0.0018 & - 0.0593 & - 0.9982 \\ - 0.9995 & 0.0320 & - 0.0037 \\ 0.0322 & 0.9977 & - 0.0592\end{matrix} ]$ | $[ \begin{matrix}- 59 \; 2.4 \\ 208.6 \\ 1660.1\end{matrix} ]$ |
| Laser head II | $[ \begin{matrix}00217 & - 0.2359 & - 0.9715 \\ - 0.9997 & 0.0 \; 091 & - 0.0246 \\ 0.0147 & 0 \text{.9717} & - 0.2356\end{matrix} ]$ | $[ \begin{matrix}- 92 \; 8.7 \\ 121.7 \\ 1596.7\end{matrix} ]$ |
| Laser head III | $[ \begin{matrix}- 0.011 & 0.1066 & - 0.9942 \\ - 0.9999 & 0 \text{.0061} & 0.0117 \\ 0.0073 & 0.9942 & 0.1065\end{matrix} ]$ | $[ \begin{matrix}- 285.7 \\ 120.1 \\ 1685.3\end{matrix} ]$ |

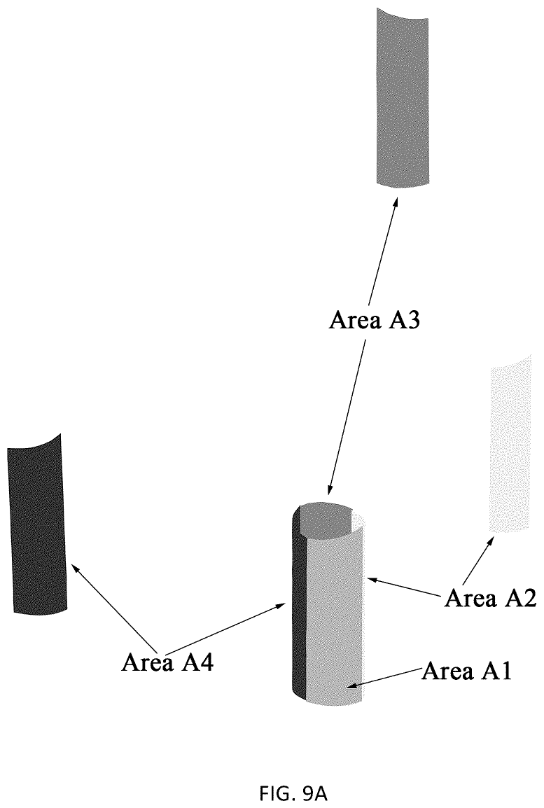

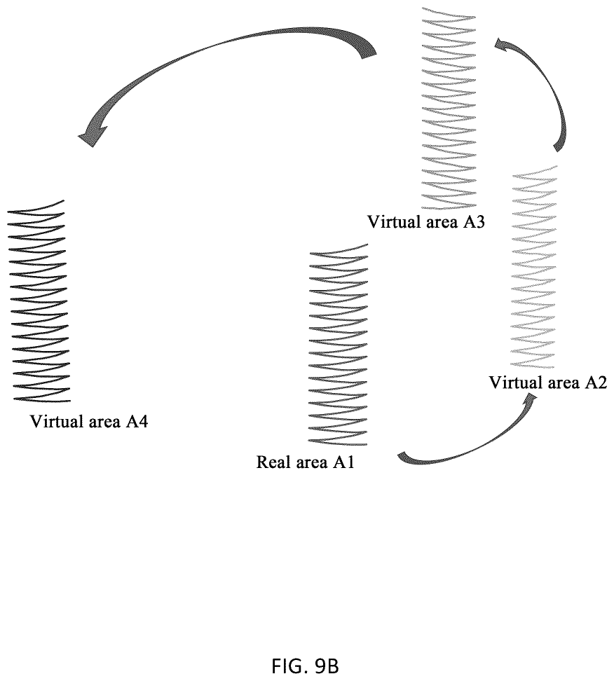

In step 2, 3D coordinates of real areas A1-A4 of the hollow cylinder specimen and those of its virtual areas A2-A4 were captured, as shown in FIG. 9A, which illustrates a diagram of profile scanning results of real areas of the hollow cylinder specimen and those of corresponding virtual areas behind the mirror. Based on captured profiles of the real area A1 and virtual areas A2-A4, 3D scan trajectories can be designed in step 3 for the whole surface of the hollow cylinder specimen, as shown in FIG. 9B, which illustrates a diagram of scan trajectories based on the real area A1 and virtual areas A2-A4 of the hollow cylinder specimen. A total of four vibration acquisitions were conducted by following the order of the real area A1, the virtual area A2, the virtual area A3, and the virtual area A4. One can see from FIG. 9B that scan trajectories for areas A2-A4 were converted to be along the same orientation as that for the area A1, which was in the FOV of the 3D CSLDV system. Coordinates of points on scan trajectories were used to determine rotating angles of scan mirrors with Eqs. 7(a)-7(c), which were fed back to the external controller.

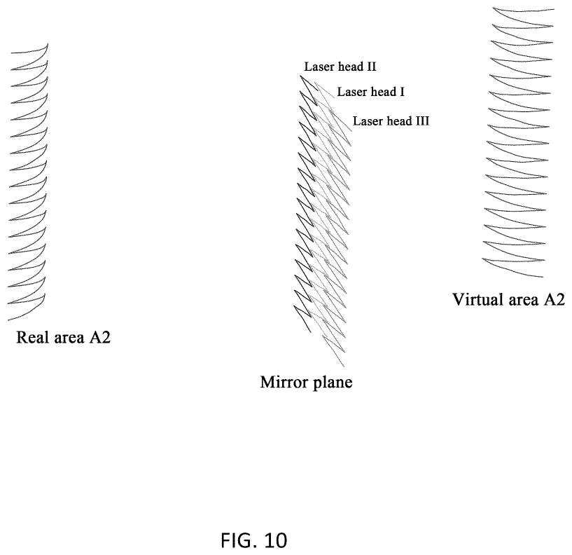

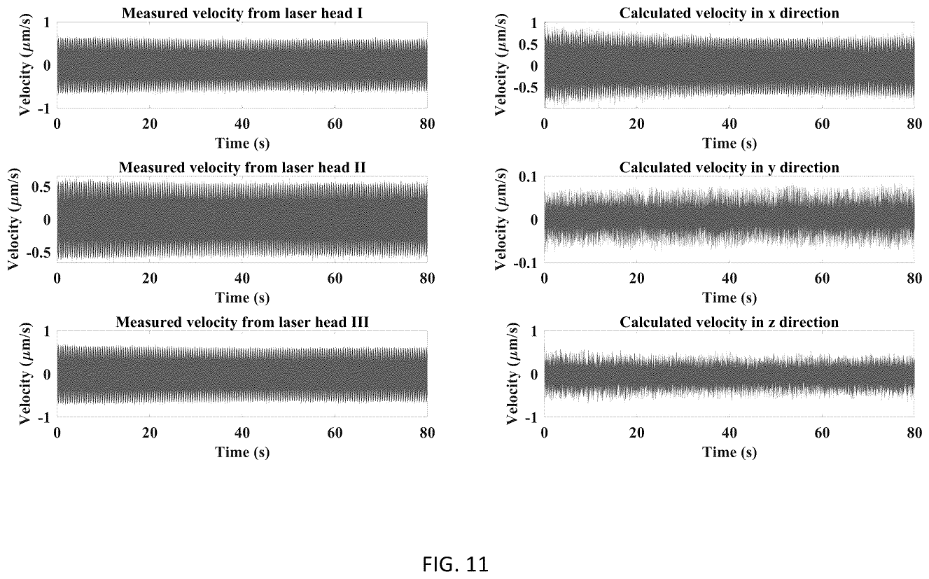

In step 4, measured vibration of areas A2-A4 was transformed to the global MCS so that they can be stitched with that of the area A1. As proposed in Section 2.3, coordinates of three points on the mirror plane were measured for each mirror position to determine its normal vector n and shown in Table 2. Note that mirror positions 1, 2, and 3 corresponded to measurement for areas A2, A3, and A4, respectively. Normal vectors in Table 2 were normalized to be unit vectors for indicating orientations of corresponding mirror planes. Calculated normal vectors and points on scan trajectories on virtual areas were then used to obtain coordinates of incident points on the mirror plane, as discussed and shown with regard to FIG. 7. For instance, FIG. 10 scan trajectories on real and virtual areas A2, and those that contained incident points of laser beams from three laser heads on the mirror plane at its position 1. FIG. 10 illustrates a diagram of scan trajectories on real and virtual areas A2 and corresponding calculated incident scan trajectories on the mirror plane. One can see that the spatial relation among three trajectories matched that of three laser heads, and scan trajectories on real and virtual areas A2 were symmetrical about the mirror plane. Virtual unit directional vectors can be obtained by using scan trajectories of incident points and the real area A2, which can then be used for transforming velocities from VCSs of three laser heads to the global MCS. As shown in FIG. 11, velocities measured by three laser heads, as shown in left three plots, were transformed to the global MCS, as shown in right three plots, for the area A2 of the hollow cylinder specimen under sinusoidal excitation with the frequency 1524 Hz. FIG. 11 illustrates velocity transformation from three laser heads to the global MCS for the area A2 of the hollow cylinder specimen under sinusoidal excitation with the frequency 1524 Hz. The scan frequency and sampling frequency of the measurement were 1 Hz and 10,000 Hz, respectively.

TABLE 1
Measured coordinates of mirror points and calculated normal
vectors of the mirror plane for its three positions

| | Mirror position 1 | Mirror position 2 | Mirror position 3 |
|---|---|---|---|
| Mirror point 1 | [−162.2 231.6 −261.7]^{T} | [−104.1 232.3 −702.1]^{T} | [−624.9 231.5 −364.5]^{T} |
| (mm) | | | |
| Mirror point 2 | [−160.7 37.4 −252.9]^{T} | [−100.4 39.0 −694.5]^{T} | [−616.3 37.5 −364.1]^{T} |
| (mm) | | | |
| Mirror point 3 | [−303.8 30.0 −383.0]^{T} | [−280.4 30.6 −766.4]^{T} | [−765.5 29.3 −243.4]^{T} |
| (mm) | | | |
| Normal vector n | [0.673 −0.028 −0.739]^{T} | [0.372 −0.029 −0.928]^{T} | [−0.628 −0.029 −0.778]^{T} |

In this work, a demodulation method was used to process the steady-state response of the hollow cylinder specimen from 3D CSLDV measurement under sinusoidal excitation to obtain its 3D ODSs at various excitation frequencies. The steady-state response u of the blade can be written as

$$u ( x , t ) = Φ ( x ) cos ( ωt - φ ) = {Φ}_{I} ( x ) cos ( ω t ) + {Φ}_{Q} ( x ) sin ( ωt ) , \qquad ( 13 )$$

where Φ(x) are responses at measurement points along the scan trajectory, which have two components that are the in-phase component Φ₁(x) and quadrature component Φ_{Q}(x), and φ is the phase variable. To obtain in-phase and quadrature components of Φ(x), multiplying u(x,t) in Eq. (13) by cos (ωt) and sin (ωt) yields

$$u ( x , t ) cos ( ω t ) = 0.5 {Φ}_{I} ( x ) + 0.5 {Φ}_{I} ( x ) cos ( 2 ω t ) + 0.5 {Φ}_{Q} ( x ) sin ( 2 ωt ) \qquad ( 14 )$$

$$u ( x , t ) sin ( ω t ) = 0.5 {Φ}_{Q} ( x ) + 0.5 {Φ}_{I} ( x ) sin ( 2 ω t ) - 0.5 {Φ}_{Q} ( x ) cos ( 2 ω t ) \qquad ( 15 )$$

respectively. A low-pass filter can then be used to eliminate sin (2ωt) and cos (2ωt) terms in both Eqs. (14) and (15), and corresponding results can be multiplied by a scale factor of two to obtain Φ₁(x) and Φ_{Q}(x), respectively.

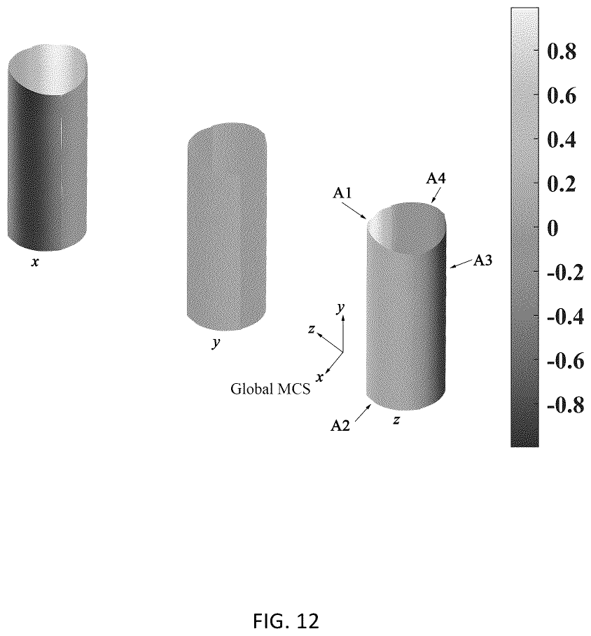

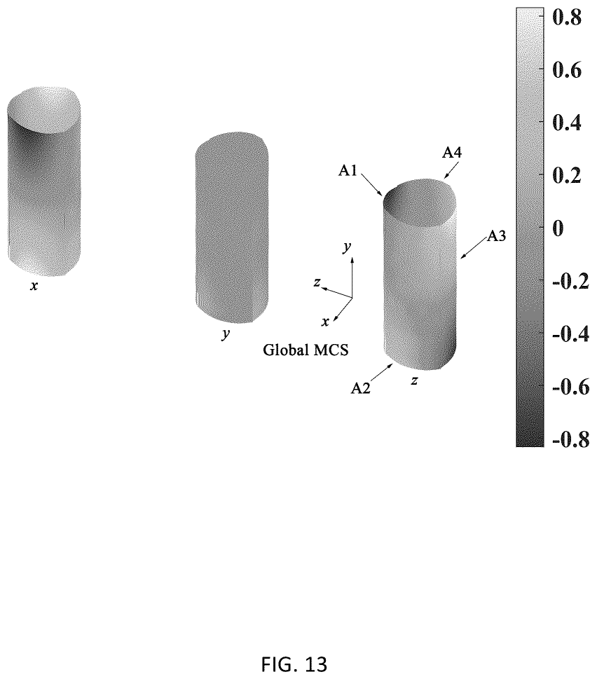

Components of 3D full-field ODSs of the hollow cylinder specimen under sinusoidal excitation with the frequency 1524 Hz along x, y, and z directions of the global MCS are normalized with unit maximum magnitude values and shown in FIG. 12, which illustrates components of 3D full-field ODSs of the hollow cylinder specimen under sinusoidal excitation with the frequency 1524 Hz along x, y, and z directions of the global MCS. Based on the global MCS shown in FIG. 12, one can see that vibration of areas A1 and A3 is mainly along the z direction and vibration of areas A2 and A4 is mainly along the x direction. Vibration along the y direction that is the longitudinal direction of the hollow cylinder specimen is much less than that along the other two directions. In this work, (m₁,m₂) that combines circumferential and axial modes is used to index the order of an ODS of the hollow cylinder specimen. The former index m₁ denotes the order of its circumferential modes that equals half of the number of circumferential nodes, and the latter index m₂ denotes the order of its axial modes that equals the number of nodal circles. One can see that FIG. 12 shows the (2,0) ODS of the hollow cylinder specimen, and similarly, FIG. 13 shows its (2,1) ODS that is obtained under sinusoidal excitation with the frequency 1593 Hz. FIG. 13 shows components of 3D full-field ODSs of the hollow cylinder specimen under sinusoidal excitation with the frequency 1593 Hz along x, y, and z directions of the global MCS.

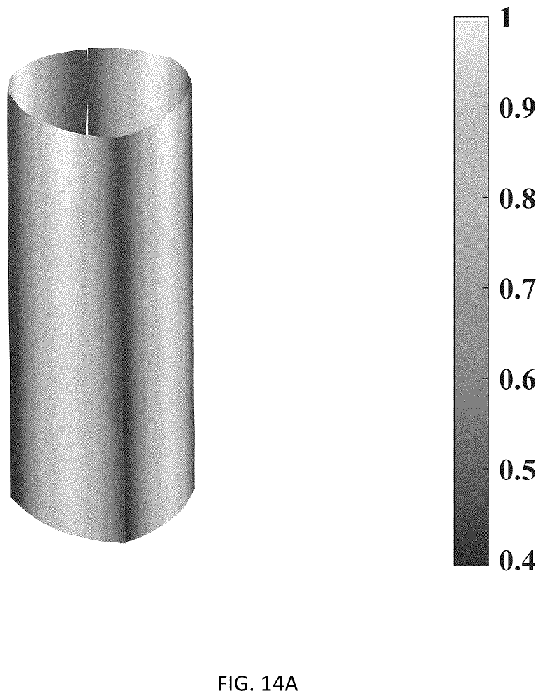

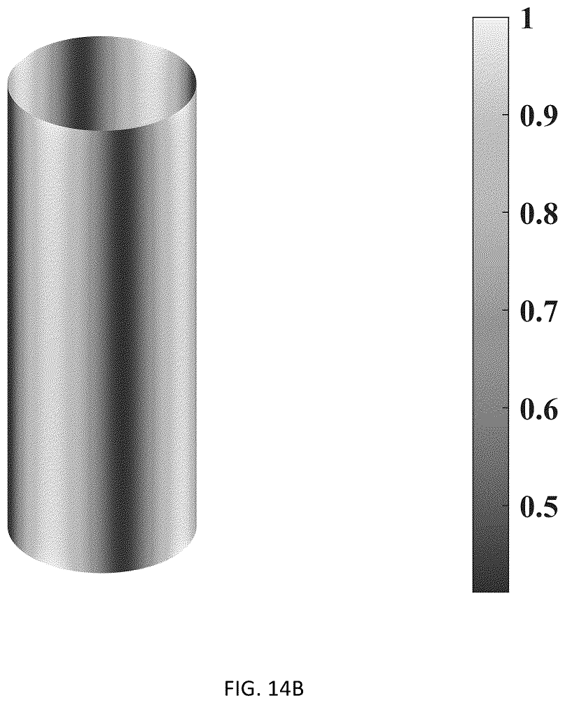

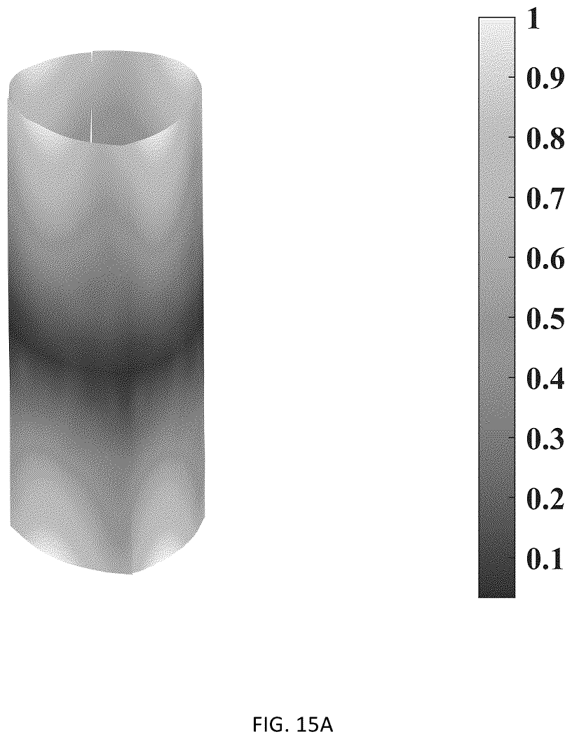

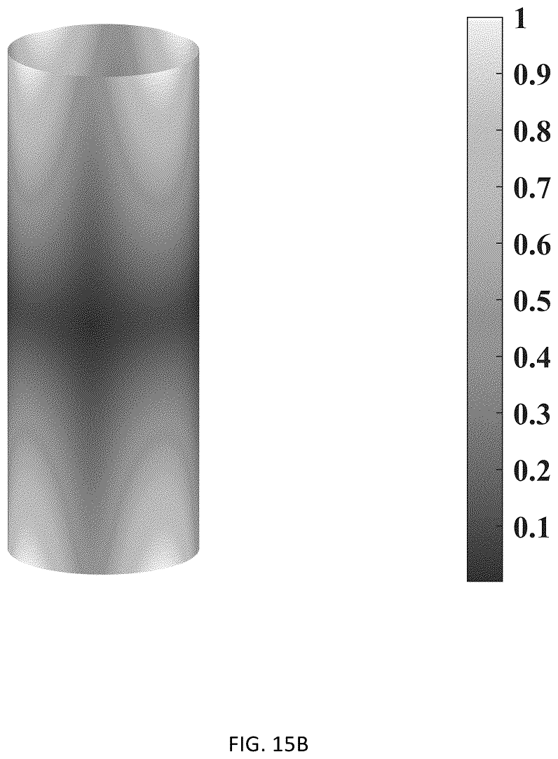

Magnitudes of 3D full-field ODSs of (2,0) and (2,1) modes of the hollow cylinder specimen from 3D CSLDV measurement and corresponding mode shapes from its FE model are shown in FIGS. 14A, 14B, 15A, and 15B, respectively. FIG. 14A shows 3D full-field ODS of the (2,0) mode of the hollow cylinder specimen from 3D CSLDV measurement, and FIG. 14B shows the corresponding mode shape from its FE model. FIG. 15A shows 3D full-field ODS of the (2,1) mode of the hollow cylinder specimen from 3D CSLDV measurement, and FIG. 15B shows the corresponding mode shape from its FE model. MAC values are used to indicate degrees of consistency between ODSs of the hollow cylinder specimen with free boundary conditions from the experiment and corresponding mode shapes from its FE model. In this work, MAC values for (2,0) and (2,1) ODSs and corresponding FE mode shapes are 0.99 and 0.98, respectively, which means that ODSs from the experiment and corresponding mode shapes from numerical simulation have high correlation.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

### REFERENCES

[1] Di Maio, D., Castellini, P., Martarelli, M., Rothberg, S., Allen, M. S., Zhu, W. D. and Ewins, D. J., 2021. Continuous Scanning Laser Vibrometry: A raison d′être and applications to vibration measurements. Mechanical systems and signal processing, 156, p. 107573.
[2] Stanbridge, A. B. and Ewins, D. J., 1999. Modal testing using a scanning laser Doppler vibrometer. Mechanical systems and signal processing, 13 (2), pp. 255-270.
[3] Allen, M. S. and Sracic, M. W., 2010. A new method for processing impact excited continuous-scan laser Doppler vibrometer measurements. Mechanical systems and signal processing, 24 (3), pp. 721-735.
[4] Lyu, L. F. and Zhu, W. D., 2021. Operational modal analysis of a rotating structure under ambient excitation using a tracking continuously scanning laser Doppler vibrometer system. Mechanical Systems and Signal Processing, 152, p. 107367.
[5] Lyu, L. F. and Zhu, W. D., 2022. Operational modal analysis of a rotating structure subject to random excitation using a tracking continuously scanning laser Doppler vibrometer via an improved demodulation method. Journal of Vibration and Acoustics, 144 (1), p. 011006.
[6] Yuan, K. and Zhu, W. D., 2021. Estimation of modal parameters of a beam under random excitation using a novel 3D continuously scanning laser Doppler vibrometer system and an extended demodulation method. Mechanical Systems and Signal Processing, 155, p. 107606.
[7] Chen, D. M., Xu, Y. F. and Zhu, W. D., 2019. A comprehensive study on detection of hidden delamination damage in a composite plate using curvatures of operating deflection shapes. Journal of Nondestructive Evaluation, 38, pp. 1-18.
[8] Xu, Y. F., Chen, D. M. and Zhu, W. D., 2019. Operational modal analysis using lifted continuously scanning laser Doppler vibrometer measurements and its application to baseline-free structural damage identification. Journal of Vibration and Control, 25 (7), pp. 1341-1364.
[9] Weekes, B. and Ewins, D., 2015. Multi-frequency, 3D ODS measurement by continuous scan laser Doppler vibrometry. Mechanical Systems and Signal Processing, 58, pp. 325-339.
[10] Chen, D. M. and Zhu, W. D., 2017. Investigation of three-dimensional vibration measurement by a single scanning laser Doppler vibrometer. Journal of Sound and Vibration, 387, pp. 36-52.
[11] Chen, D. M. and Zhu, W. D., 2021. Investigation of three-dimensional vibration measurement by three scanning laser Doppler vibrometers in a continuously and synchronously scanning mode. Journal of Sound and Vibration, 498, p. 115950.
[12] Yuan, K. and Zhu, W. D., 2022. In-plane operating deflection shape measurement of an aluminum plate using a three-dimensional continuously scanning laser Doppler vibrometer system. Experimental Mechanics, pp. 1-10.
[13] Yuan, K. and Zhu, W. D., 2022. A novel general-purpose three-dimensional continuously scanning laser Doppler vibrometer system for full-field vibration measurement of a structure with a curved surface. Journal of Sound and Vibration, 540, p. 117274.
[14] Yuan, K. and Zhu, W. D., 2023. Identification of modal parameters of a model turbine blade with a curved surface under random excitation with a three-dimensional continuously scanning laser Doppler vibrometer system. Measurement, 214, p. 112759.
[15] Chen, Y., Escalera Mendoza, A. S. and Griffith, D. T., 2022. Experimental dynamic characterization of both surfaces of structures using 3D scanning laser Doppler vibrometer. Experimental Techniques, pp. 1-18.
[16] Chen, B. and Pan, B., 2019. Mirror-assisted panoramic-digital image correlation for full-surface 360-deg deformation measurement. Measurement, 132, pp. 350-358.
[17] Pan, B. and Chen, B., 2019. A novel mirror-assisted multi-view digital image correlation for dual-surface shape and deformation measurements of sheet samples. Optics and Lasers in Engineering, 121, pp. 512-520.
[18] Witt, B., Rohe, D., Schoenherr, T., 2019. Full-field strain shape estimation from 3D SLDV. In: Niezrecki, C., Bagersad, J., Di Maio, D. (eds) Rotating Machinery, Optical Methods & Scanning LDV Methods, Volume 6. Conference Proceedings of the Society for Experimental Mechanics Series. Springer, Cham.
[19] Yuan, K. and Zhu, W., 2021. Modeling of welded joints in a pyramidal truss sandwich panel using beam and shell finite elements. Journal of Vibration and Acoustics, 143 (4), p. 041002.
[20] Stanbridge, A. B., Ind, P. R. and Ewins, D. J., 2004 June. Measuring vibration of cylindrical surfaces using a continuous-scan LDV. In Sixth International Conference on Vibration Measurements by Laser Techniques: Advances and Applications (Vol. 5503, pp. 249-259). SPIE.
[21] Schwingshackl, C. W., Massei, L., Zang, C. and Ewins, D. J., 2010. A constant scanning LDV technique for cylindrical structures: Simulation and measurement. Mechanical Systems and Signal Processing, 24 (2), pp. 394-405.
[22] Li, C., Zhang, Z., Yang, Q. and Li, P., 2020. Experiments on the geometrically nonlinear vibration of a thin-walled cylindrical shell with points supported boundary condition. Journal of Sound and Vibration, 473, p. 115226.
[23] Rawat, A., Matsagar, V. A. and Nagpal, A. K., 2020. Free vibration analysis of thin circular cylindrical shell with closure using finite element method. International Journal of Steel Structures, 20 (1), pp. 175-193.
[24] Ewins, D. J., 2009. Modal testing: theory, practice and application. John Wiley & Sons.

What is claimed is:

1. A three-dimensional (3D) continuously scanning laser vibrometer (CSLV) system comprising:
first, second, and third laser heads configured to be positioned for scanning at least one first side of a structure within a field-of-view (FOV) of the first, second, and third laser heads;
a mirror configured to be positioned for reflection for enabling the first, second, and third laser heads to scan at least one second side of the structure beyond the FOVs of the first, second, and third laser heads; and
a computing device operably connected to the first, second, and third laser heads, wherein the computing device is configured to:
control the first, second, and third laser heads to scan the at least one first side of the structure;
measure the 3D vibrations of the at least one first side of the structure;
control the first, second, and third laser heads to point towards the mirror for scanning the at least one second side of the structure;
measure the 3D vibrations of the at least one second side of the structure; and
determine operating deflection shapes (ODSs) of the structure based on the measured 3D vibrations of the at least one first side of the structure and the at least one second side of the structure.

2. The system of claim 1, wherein the at least one first side of the structure and/or the at least one second side of the structure are curved.

3. The system of claim 1, wherein the operating deflection shapes of the structure includes a first set of operating deflection shapes determined based on the measured 3D vibrations of the at least one first side of the structure, and wherein the operating deflection shapes of the structure includes a second set of operating deflection shapes based on the measured 3D vibrations of the at least one second side of the structure, and
wherein the first set of operating deflection shapes and the second set of operating deflection shapes are stitched together for generating panoramic 3D operating shapes of the structure.

4. The system of claim 1, wherein the computing device is configured to control the first, second, and third laser heads to continuously and synchronously to move along the same scan trajectory on the at least one first side of the structure.

5. The system of claim 1, wherein the computing device is configured to control the first, second, and third laser heads to use the mirror for continuously and synchronously moving along the same scan trajectory on the at least one second side of the structure.

6. The system of claim 1, wherein the second and third laser heads are positioned between about 30 degrees and 60 degrees relative to the first laser head.

7. The system of claim 1, wherein the computing device is configured to use a reference object as a measurement coordinate system for calibration.

8. The system of claim 1, wherein the first, second, and third laser heads scan the at least one first side and the at least one second side of the structure under sinusoidal excitation.

9. The system of claim 1, wherein the mirror or one or more other mirrors are placed at another position for reflection for enabling the first, second, and third laser heads to scan at least one third side of the structure, wherein the at least one third side of the structure is different than the at least one first side and the at least one second side, and
wherein the computing device is configured to:
control the first, second, and third laser heads to point towards the mirror or one or more other mirrors at the other position for scanning the at least one third side of the structure;
measure the 3D vibrations of the at least one third side of the structure; and
determine operating deflection shapes of the structure based on the measured 3D vibrations of the at least one third side of the structure.

10. The system of claim 1, wherein the mirror is positioned such that all of the at least one second side of the structure is scannable by the first, second, and third laser heads.

11. The system of claim 1, wherein the controller is configured to determine vibration of the structure based on the measured 3D vibrations of the at least one first side of the structure and the at least one second side of the structure.

12. A method comprising:
positioning first, second, and third laser heads for scanning at least one first side of a structure within field-of-views (FOVs) of the first, second, and third laser heads;
positioning a mirror for reflection for enabling the first, second, and third laser heads to scan at least one second side of the structure beyond the FOVs of the first, second, and third laser heads;
controlling the first, second, and third laser heads to scan the at least one first side of the structure;
measuring the 3D vibrations of the at least one first side of the structure;
controlling the first, second, and third laser heads to point towards the mirror for scanning the at least one second side of the structure;
measuring the 3D vibrations of the at least one second side of the structure; and
determining operating deflection shapes (ODSs) of the structure based on the measured 3D vibrations of the at least one first side of the structure and the at least one second side of the structure.

13. The method of claim 12, wherein the at least one first side of the structure and/or the at least one second side of the structure are curved.

14. The method of claim 12, wherein the operating deflection shapes of the structure includes a first set of operating deflection shapes determined based on the measured 3D vibrations of the at least one first side of the structure, and wherein the operating deflection shapes of the structure includes a second set of operating deflection shapes based on the measured 3D vibrations of the at least one second side of the structure, and
wherein the method further comprises stitching together the first set of operating deflection shapes and the second set of operating deflection shapes for generating panoramic 3D operating shapes of the structure.

15. The method of claim 12, further comprising controlling the first, second, and third laser heads to continuously and synchronously to move along the same scan trajectory on the at least one first side of the structure.

16. The method of claim 12, further comprising controlling the first, second, and third laser heads to use the mirror for continuously and to synchronously to move along the same scan trajectory on the at least one second side of the structure.

17. The method of claim 12, wherein the second and third laser heads are positioned between about 30 degrees and 60 degrees relative to the first laser head.

18. The method of claim 12, further comprising using a reference object as a measurement coordinate system for calibration.

19. The method of claim 12, further comprising controlling the first, second, and third laser heads to scan the at least one first side and the at least one second side of the structure under sinusoidal excitation.

20. The method of claim 12, wherein the mirror or one or more other mirrors are placed at another position for reflection for enabling the first, second, and third laser heads to scan at least one third side of the structure, wherein the at least one third side of the structure is different than the at least one first side and the at least one second side, and
wherein the method further comprises:
controlling the first, second, and third laser heads to point towards the mirror or one or more other mirrors at the other position for scanning the at least one third side of the structure;
measuring the 3D vibrations of the at least one third side of the structure; and
determining operating deflection shapes of the structure based on the measured 3D vibrations of the at least one third side of the structure.

21. The method of claim 12, wherein the mirror is positioned such that all of the at least one second side of the structure is scannable by the first, second, and third laser heads.

22. The method of claim 12, further comprising determining vibration of the structure based on the measured 3D vibrations of the at least one first side of the structure and the at least one second side of the structure.
